(19) United States
(12) Patent Application Publication
(10) Pub. No.: US 2026/0198571 A1
(43) Pub. Date: Jul. 16, 2026

(54) AEROSOL-GENERATING ARTICLE

(71) Applicant: Philip Morris Products S.A., Neuchatel (CH)

(72) Inventors: Matteo BOLOGNA, Lausanne (CH); Bruno Christian Joseph CHASSOT, Auvernier (CH); Onur DAYIOGLU, Neuchatel (CH); Marie Rose Danielle FARINE, Sugiez (CH); Jerome UTHURRY, Neuchatel (CH)

(73) Assignee: Philip Morris Products S.A., Neuchatel (CH)

(21) Appl. No.: 19/136,944

(22) PCT Filed: Dec. 21, 2023
(86) PCT No.: PCT/EP2023/087259

§ 371 Date: Jun. 9, 2025

(30) Foreign Application Priority Data
Dec. 23, 2022 (EP) 22216422

(51) Int. Cl. A24F 40/42; A24F 40/48

(52) U.S. Cl. CPC A24F 40/42; A24F 40/48

(57) ABSTRACT

An aerosol-generating article for an aerosol-generating device is provided, the article including: substantially planar upper and lower surfaces, the substantially planar upper and lower surfaces being vertically spaced from each other by a height defined in a z direction; an aerosol-forming substrate; and a laminated structure disposed between the substantially planar upper and lower surfaces, the laminated structure including two or more layers overlying each other, the layers including paper or cardboard, the laminated structure defining at least part of an air flow path through the article between distal and proximal ends of the article, the laminated structure further defining a frame, the frame defining one or more cavities, the air flow path extending through the one or more cavities, and at least 50% wt of the article being paper or cardboard.

The present disclosure relates to an aerosol-generating article comprising an aerosol-forming substrate.

A typical aerosol-generating article may appear similar to a conventional cigarette. For example, such an aerosol-generating article may be a substantially cylindrical article comprising an aerosol-forming substrate and other components such as mouthpiece filter element, all wrapped in a cigarette paper. Dimensions of typical aerosol-generating articles are often similar to the dimensions of conventional cigarettes.

Research has shown that, in such a typical aerosol-generating article comprising a plug of aerosol-forming substrate, a significant portion of the plug of aerosol-forming substrate may not be sufficiently heated to form an aerosol during use. This is undesirable since this portion of the plug of aerosol-forming substrate contributes to the cost of manufacture and transport of the aerosol-generating article, but does not contribute to the aerosol delivered to an end user. This may be the case regardless of the way in which the aerosol-forming substrate is heated, for example regardless of whether a resistive or inductive heater is used and regardless of whether the plug of aerosol-forming substrate is heated from the inside or the outside.

It is an aim of the present disclosure to provide an aerosol-generating article, in which a greater portion of an aerosol-forming substrate of the aerosol-generating article is sufficiently heated to form an aerosol during use.

According to the present disclosure, there may be provided an aerosol-generating article comprising an aerosol-forming substrate for producing an aerosol, the aerosol-generating article being a planar aerosol-generating article having a base defined by a length extending in an x direction, a width extending in a y direction, and a height extending in a z direction. At least 50% wt of the aerosol-generating article may be paper or cardboard.

According to the present disclosure, there may be provided an aerosol-generating article comprising an aerosol-forming substrate for producing an aerosol, the aerosol-generating article comprising a substantially planar upper surface defined by a length extending in an x direction and a width extending in a y direction, and a substantially planar lower surface defined by a length extending in an x direction and a width extending in a y direction. The substantially planar upper surface and the substantially planar lower surface may be vertically spaced from each other by a height defined in a z direction. At least 50% wt of the aerosol-generating article may be paper or cardboard.

According to the present disclosure, there may be provided an aerosol-generating article for use with an aerosol-generating device, the aerosol-generating article comprising a substantially planar upper surface and a substantially planar lower surface, and an aerosol-forming substrate. The upper surface and the lower surface may be vertically spaced from each other by a height defined in a z direction. At least 50% wt of the aerosol-generating article may be paper or cardboard.

The substantially planar upper surface may be defined by a length extending in an x direction and a width extending in a y direction.

The substantially planar lower surface may be defined by a length extending in an x direction and a width extending in a y direction.

The use of paper or cardboard to form a majority of the mass of the aerosol-generating article may provide an article which can be disposed of and/or recycled with a reduced environmental impact. For example, the use of paper or cardboard in preference to cellulose acetate enhances disposability and recyclability of the aerosol-generating article.

The aerosol-generating article of the present disclosure is generally flat and thin. The provision of a generally flat and thin aerosol-generating article provides for rapid and efficient heating of the aerosol-forming substrate and improved uniformity in through-thickness heating. The use of paper or cardboard to form at least 50% wt of the aerosol-generating article provides an aerosol-generating article with improved sustainability. Paper and cardboard are also particularly suitable to be formed and provided in planar form, in keeping with the planar geometry of the aerosol-generating article of the present disclosure. Preferably, the aerosol-generating article is free of any single-use plastics. The aerosol-forming substrate is preferably porous and/or of low density, thereby reducing the resistance to air flow through the aerosol-forming substrate (for example, where the aerosol-generating article has an air flow path extending through the aerosol-generating article).

At least 55% wt, or at least 60% wt, or at least 65% wt, or at least 70% wt, or at least 75% wt, or at least 80% wt, or at least 85% wt, or at least 90% wt of the aerosol-generating article, excluding the aerosol-forming substrate, may be paper or cardboard. Increasing the proportion of the aerosol-generating article made from paper or cardboard enhances disposability and recyclability of the aerosol-generating article with a reduced environmental impact. Advantageously, substantially the entirety of the aerosol-generating article, excluding the aerosol-forming substrate and (if present) adhesive, may be paper or cardboard.

Preferably, the aerosol-generating article has a cellulose acetate content of less than 5%, or less than 3%, or less than 1%. Facilities for the recycling of cellulose acetate are relatively uncommon. So, reducing the content of cellulose acetate will enhance recyclability of the aerosol-generating article.

The aerosol-generating article may comprise a frame disposed between the substantially planar upper surface and the substantially planar lower surface. The frame may define one or more cavities. The frame may comprise or consist of paper or cardboard. The one or more cavities defined by the frame may contain aerosol-forming substrate and/or may form part of an air flow path extending through the aerosol-generating article.

The aerosol-generating article may comprise a laminated structure disposed between the substantially planar upper surface and the substantially planar lower surface. The laminated structure may comprise two or more layers overlying each other. The layers may comprise or consist of paper or cardboard.

Preferably, the laminated structure may define a frame, the frame defining one or more cavities. The one or more cavities may contain aerosol-forming substrate and/or may form part of an air flow path extending through the aerosol-generating article.

The layers of the laminated structure may be bonded to each other by an adhesive, optionally the adhesive being guar gum or PVOH.

Each of the layers may extend over a length of the aerosol-generating article.

Each of the layers of the laminated structure may have a thickness in a range of between 0.1 millimetres to 5 millimetres, or between 0.4 millimetres to 4 millimetres, or about 0.5 millimetres, or about 1 millimetres.

The laminated structure may define at least part of an air flow path through the aerosol-generating article between a distal end and a proximal end of the aerosol-generating article. The laminated structure may define a frame, the frame defining one or more cavities, the air flow path extending through the one or more cavities. At least part of the aerosol-forming substrate may be disposed in the cavity.

The paper or cardboard may have a basis weight equal to or greater than 300 grammes per square metre. The paper or cardboard may have a basis weight equal to or greater than 350 grammes per square metre. The paper or cardboard may have a basis weight equal to or greater than 390 grammes per square metre. The paper or cardboard may have a basis weight equal to or greater than 420 grammes per square metre. The paper or cardboard may have a basis weight equal to or greater than 620 grammes per square metre. The paper or cardboard may have a basis weight equal to or greater than 720 grammes per square metre. The paper or cardboard may have a basis weight equal to or greater than 800 grammes per square metre.

The paper or cardboard may have a basis weight equal to or less than 900 grammes per square metre. The cellulosic material may have a basis weight equal to or less than 800 grammes per square metre. The paper or cardboard may have a basis weight equal to or less than 720 grammes per square metre. The paper or cardboard may have a basis weight equal to or less than 620 grammes per square metre. The paper or cardboard may have a basis weight equal to or less than 420 grammes per square metre. The paper or cardboard may have a basis weight equal to or less than 390 grammes per square metre. The paper or cardboard may have a basis weight equal to or less than 350 grammes per square metre.

The paper or cardboard may have a basis weight between 300 grammes per square metre to 900 grammes per square metre. The paper or cardboard may have a basis weight between 300 grammes per square metre to 800 grammes per square metre. The paper or cardboard may have a basis weight between 350 grammes per square metre to 800 grammes per square metre. The paper or cardboard may have a basis weight between 400 grammes per square metre to 700 grammes per square metre.

The frame or the laminated structure preferably may extend in a z direction over at least 85%, or at least 90%, or at least 95%, or at least 97.5%, or 100% of the height. The frame or laminated structure may provide the majority of the flexural stiffness possessed by the aerosol-generating article.

The frame or the laminated structure may have a height defined in a z-direction, the height of the frame or the laminated structure being no more than 5 millimetres.

The upper surface and the lower surface may be parallel to each other.

The aerosol-generating article may have a length extending between a distal end and a proximal end of the aerosol-generating article, the aerosol-forming substrate extending over at least part of the length of the aerosol-generating article. The aerosol-forming substrate may extend over the entire length of the aerosol-generating article. The aerosol-forming substrate may extend over part of the length of the aerosol-generating article and be positioned closer to the distal end than to the proximal end. The aerosol-forming substrate may extend to the distal end. The proximal end may be a mouth end of the aerosol-generating article.

An air-flow path may be defined through the aerosol-generating article between a distal end and a proximal end of the aerosol-generating article.

Aerosol-generating articles according to the present disclosure may preferably be substantially flat articles or substantially planar articles. Such articles have a large base area relative to the volume of the article. Advantageously, a larger base area may provide greater surface area for heating by a planar heater of an aerosol-generating device. Advantageously, a smaller height may allow a smaller temperature gradient or difference across the height of the aerosol-generating article during heating. For example, where the base of the aerosol-generating article is in contact with, and heated by, a planar heater, there may be a smaller temperature difference between the base and an upper surface opposing the base if the spacing, or height, between the base and the upper surface is smaller. Advantageously, this may allow heating of a greater proportion of the aerosol-forming substrate of the aerosol-generating article to a temperature at which an aerosol is released, whilst minimising the risk of burning the hottest portion of the substrate closest to the heater. Alternatively, or in addition, this may reduce a time required to heat the aerosol-forming substrate sufficiently to release an aerosol.

The aerosol-generating article according to any of the aspects disclosed herein may have an air flow path extending through the aerosol-generating article. The aerosol-generating article may have an air-flow path defined through the aerosol-generating article in an x/y plane from one side of the aerosol-generating article to the other side of the aerosol-generating article. The aerosol-generating article preferably has a resistance to draw (RTD) of less than 20 millimetre H₂O, for example less than 10 millimetre H₂O, in the direction of the airflow path. Preferably, the aerosol-generating article has a RTD of less than 20 millimetre H₂O, for example less than 10 millimetre H₂O, in at least one direction in an x/y plane of the aerosol-generating article. An aerosol-generating article with a low resistance air-flow path may allow for superior air-flow management and allow aerosol to be extracted more efficiently from the aerosol-generating article and guided to a user.

Unless otherwise specified, the resistance to draw (RTD) is measured in accordance with ISO 6565-2015. The RTD refers to the pressure required to force air through the full length of a component, such as the aerosol-generating article. The terms “pressure drop” or “draw resistance” of a component or article may also refer to the “resistance to draw”. Such terms generally refer to the measurements made in accordance with ISO 6565-2015 and are normally carried out at under test at a volumetric flow rate of about 17.5 millilitres per second at the output or downstream end of the measured component at a temperature of about 22 degrees Celsius, a pressure of about 101 kPa (about 760 Torr) and a relative humidity of about 60%.

The aerosol-generating article according to any of the aspects disclosed herein may comprise substantially planar upper and lower surfaces. A vertical separation between the substantially planar upper and lower surfaces may define a height (for example, a z dimension) of the aerosol-generating article. An air flow channel may be defined between the substantially planar upper and lower surfaces. The height of the aerosol-generating article may be less than 5 millimetres, for example between 1.5 millimetres and 5 millimetres, for example between 1.5 millimetres and 4 millimetres, for example between 1.5 millimetres and 3 millimetres, for example between 1.5 millimetres and 2 millimetres. One or both of the substantially planar upper and lower surfaces may comprise an aerosol-forming substrate. The aerosol-generating article may comprise upper and lower layers, at least one of the upper and lower layers comprising or consisting of aerosol-forming substrate, the upper layer forming the substantially planar upper surface and the lower layer forming the substantially planar lower surface.

The aerosol-generating article may further comprise an intermediate layer arranged between an upper layer and a lower layer. The upper surface may define an external surface of the upper layer and the lower surface define an external surface of the lower layer. An air flow path may be defined through the aerosol-generating article in an x/y plane between a distal end and a proximal end of the aerosol-generating article.

A resistance to draw (RTD) of the aerosol-generating article, along the air-flow path, may be less than 20 millimetre H₂O.

One or more of the upper layer, the intermediate layer and the lower layer may comprise or consist of paper or cardboard.

One or both of the upper layer and the lower layer may comprise or consist of aerosol-forming substrate, the intermediate layer comprising or consisting of paper or cardboard.

The intermediate layer may comprise or consist of aerosol-forming substrate, and the upper layer and the lower layer comprise or consist of paper or cardboard.

A plurality of longitudinally extending channels may be defined by corrugations between the upper layer and the intermediate layer and between the intermediate layer and the lower layer. The longitudinally extending channels may extend along in an x/y plane between the distal end and the proximal end.

The intermediate layer may be fixed relative to at least one of the upper layer and lower layer by an adhesive. By way of example, the adhesive may comprise guar gum. The adhesive may comprise an aerosol-forming material, such as homogenised tobacco slurry.

The intermediate layer may comprise a corrugated element. The corrugated element may comprise or consist of aerosol-forming substrate. The corrugated element may comprise or consist of paper or cardboard.

The intermediate layer may comprise a plurality of corrugated elements, in which two or more of the plurality of corrugated elements may be arranged in vertical relationship to each other between the upper layer and the lower layer. The intermediate layer may further comprise a planar element positioned between two of the plurality of corrugated elements.

According to the present disclosure, there may be provided an aerosol-generating article comprising a first planar layer, a second planar layer, and a corrugated layer arranged between the first planar layer and the second planar layer. At least one of the first planar layer, the second planar layer and the corrugated layer may comprise or consist of an aerosol-forming substrate. At least 50% wt of the aerosol-generating article may be paper or cardboard.

The use of a corrugated structure in the aerosol-generating article may advantageously allow the production of an aerosol-generating article that has extremely low RTD while still being sufficiently rigid to for a user to handle. Further, use of a corrugated structure may allow a low density, low RTD, aerosol-generating article to be produced using high speed production methods similar to those used for production of corrugated cardboard.

The aerosol-generating article may further comprise a planar frame positioned between an upper layer and a lower layer. The upper surface may define an external surface of the upper layer. The lower surface may define an external surface of the lower layer. The planar frame may define a cavity. An air flow path may be defined through the aerosol-generating article in an x/y plane, the air-flow path extending through the cavity.

The upper layer and the lower layer may be coupled to opposing surfaces of the frame to overlie opposing ends of the cavity.

Preferably, one or more of the upper layer, the lower layer and the frame may comprise or consist of paper or cardboard. Preferably, at least the frame comprises or consists of paper or cardboard. Advantageously, each of the upper layer, the lower layer and the frame comprise or consist of cardboard.

Where one or both of the upper layer and the lower layer comprise or consist of paper or cardboard: The paper or cardboard used for the upper and/or lower layers may have a basis weight greater than 10 grammes per square metre. The paper or cardboard used for the upper and/or lower layers may have a basis weight greater than 20 grammes per square metre. The paper or cardboard used for the upper and/or lower layers may have a basis weight less than 30 grammes per square metre. The paper or cardboard used for the upper and/or lower layers may have a basis weight of less than 25 grammes per square metre. The paper or cardboard used for the upper and/or lower layers may have a basis weight between 10 grammes per square metre and 30 grammes per square metre. The paper or cardboard used for the upper and/or lower layers may have a basis weight between 15 grammes per square metre and 25 grammes per square metre.

Where the frame comprises or consists of paper or cardboard: The paper or cardboard used for the frame may have a basis weight equal to or greater than 300 grammes per square metre. The paper or cardboard used for the frame may have a basis weight equal to or greater than 350 grammes per square metre. The paper or cardboard used for the frame may have a basis weight equal to or greater than 390 grammes per square metre. The paper or cardboard used for the frame may have a basis weight equal to or greater than 420 grammes per square metre. The paper or cardboard used for the frame may have a basis weight equal to or greater than 620 grammes per square metre. The paper or cardboard used for the frame may have a basis weight equal to or greater than 720 grammes per square metre. The paper or cardboard used for the frame may have a basis weight equal to or greater than 800 grammes per square metre.

Where the frame comprises or consists of paper or cardboard: The paper or cardboard used for the frame may have a basis weight equal to or less than 900 grammes per square metre. The paper or cardboard used for the frame may have a basis weight equal to or less than 800 grammes per square metre. The paper or cardboard used for the frame may have a basis weight equal to or less than 720 grammes per square metre. The paper or cardboard used for the frame may have a basis weight equal to or less than 620 grammes per square metre. The paper or cardboard used for the frame may have a basis weight equal to or less than 420 grammes per square metre. The paper or cardboard used for the frame may have a basis weight equal to or less than 390 grammes per square metre. The paper or cardboard used for the frame may have a basis weight equal to or less than 350 grammes per square metre.

Where the frame comprises or consists of paper or cardboard: The paper or cardboard used for the frame may have a basis weight between 300 grammes per square metre to 900 grammes per square metre. The paper or cardboard used for the frame may have a basis weight between 300 grammes per square metre to 800 grammes per square metre. The paper or cardboard used for the frame may have a basis weight between 350 grammes per square metre to 800 grammes per square metre. The paper or cardboard used for the frame may have a basis weight between 400 grammes per square metre to 700 grammes per square metre.

One or both of the upper layer and the lower layer may comprise or consist of aerosol-forming substrate, the frame comprising or consisting of paper or cardboard.

Both the upper layer and the lower layer may comprise or consist of paper or cardboard, the frame comprising or consisting of aerosol-forming substrate.

Preferably, each of the upper layer, the lower layer and the frame may comprise or consist of paper or cardboard. Aerosol-forming substrate may be contained within the cavity between the upper and lower layers.

A corrugated element may be disposed within the cavity between the upper and lower layers. The corrugated element may comprise or consist of aerosol-forming substrate. The corrugated element may comprise or consist of paper or cardboard. A plurality of longitudinally extending channels may be defined by corrugations between the upper layer and the corrugated element and between the corrugated element and the lower layer. The longitudinally extending channels may extend along in an x/y plane between opposing ends of the frame.

Preferably, the air-flow path is at least partially defined by the frame. The frame may comprise an inlet air-flow channel and an outlet air-flow channel, the inlet air-flow channel configured to permit a flow of air into the cavity and the outlet air-flow channel configured to permit a flow of air to exit the cavity. The inlet air-flow channel and the outlet air-flow channel may be defined on opposing ends of the frame. The inlet air-flow channel may be defined in a first width edge of the frame and the outlet air-flow channel defined in a second width edge of the frame.

According to the present disclosure, there may be provided an aerosol-generating article, the aerosol-generating article comprising: a first planar external surface, a second planar external surface, a cavity, a frame positioned between the first planar external surface and the second planar external surface, the frame at least partially defining the cavity, an aerosol-forming substrate positioned between the first planar external surface and the second planar external surface, and an air inlet and an air outlet, and an airflow passage extending between the air inlet and the air outlet through the cavity. At least 50% wt of the aerosol-generating article may be paper or cardboard

The frame may be as described in any of the preceding paragraphs.

The frame may comprise a peripheral wall at least partially circumscribing or encircling the cavity. The frame may comprise a peripheral wall wholly circumscribing or encircling the cavity.

The aerosol-generating article may comprise a first planar external layer and a second planar external layer, in which the first planar external layer forms the first planar external surface and the second planar external layer forms the second planar external surface. Optionally, at least one of the first planar external layer, the second planar external layer, and the frame may comprise or consist of aerosol-forming substrate.

The cavity may be substantially empty.

Aerosol-forming substrate may be positioned within the cavity.

A corrugated layer may be positioned within the cavity.

The aerosol-generating article of any of the aspects of the present disclosure may have a length (for example, an x dimension) of between 10 millimetres and 100 millimetres, or between 10 millimetres and 50 millimetres, for example between 12 millimetres and 30 millimetres, for example between 14 millimetres and 26 millimetres, for example between 16 millimetres and 24 millimetres, for example between 18 millimetres and 22 millimetres, for example about 18 millimetres, or about 19 millimetres, or about 20 millimetres, or about 21 millimetres, or about 22 millimetres.

The aerosol-generating article may have a width (for example, a y dimension) of between 5 millimetres and 20 millimetres, for example between 8 millimetres and 18 millimetres, for example between 10 millimetres and 16 millimetres, for example between 11 millimetres and 15 millimetres, for example between 12 millimetres and 14 millimetres, for example about 13 millimetres.

The aerosol-generating article may have a height (for example, a z dimension) of between 1 millimetres and 10 millimetres, for example between 1.2 millimetres and 8 millimetres, for example between 1.4 millimetres and 7 millimetres, for example between 1.6 millimetres and 6 millimetres, for example between 1.7 millimetres and 5 millimetres, for example about 1.7 millimetres, or about 4.5 millimetres, or about 2 millimetres, or about 3 millimetres, or about 4 millimetres.

The aerosol-generating article of any of the aspects of the present disclosure when viewed in plan may have a shape defining a polygon, a quadrilateral (for example, a rectangle or a square), oval, or circle, or a combination thereof. Where the aerosol-generating article comprises substantially planar upper and lower surfaces, one or both of the upper and lower surfaces when viewed in plan may have a shape defining a polygon, a quadrilateral (for example, a rectangle or a square), an oval, a circle, or a combination thereof. A perimeter of the aerosol-generating article when viewed in plan may be formed of a plurality of straight sides, a plurality of curved sides, or a combination of straight and curved sides. Where the aerosol-generating article comprises substantially planar upper and lower surfaces, a perimeter of one or both of the upper and lower surfaces when viewed in plan may have a shape defining a polygon, a quadrilateral (for example, a rectangle or a square), an oval, a circle, or a combination thereof.

The aerosol-generating article may consist entirely of aerosol-forming substrate. Alternatively, the aerosol-forming substrate may be one of a plurality of component parts of the aerosol-generating article.

The aerosol-forming substrate may comprise nicotine. Nicotine may be present in the form of a tobacco material or may be in the form of a nicotine extract.

Preferably, the aerosol-forming substrate comprises, or consists of, homogenised tobacco material, for example a reconstituted tobacco material or a cast leaf tobacco material.

The aerosol-forming substrate may comprise, or consist of, a solid aerosol-forming material. The aerosol-forming substrate may comprise a liquid aerosol-forming material, for example a liquid aerosol-forming material retained within a porous matrix. The aerosol-forming substrate may comprise a gel aerosol-forming material.

The aerosol-forming substrate may comprise one or more aerosol-formers. Suitable aerosol-formers are well known in the art and include, but are not limited to, one or more aerosol-formers selected from: polyhydric alcohols, such as propylene glycol, polyethylene glycol, triethylene glycol, 1, 3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. It may be particularly preferable for the aerosol-former to be or comprise glycerine.

The aerosol-forming substrate may comprise at least 1, 2, 5, 10, or 15 weight percent aerosol-former. The aerosol-forming substrate may comprise greater than 15 weight percent aerosol-former, for example greater than 20 weight percent, or greater than 25 weight percent, or greater than 30 weight percent, or greater than 40 weight percent, or greater than 50 weight percent aerosol-former.

The aerosol-forming substrate may comprise less than or equal to 30 percent by weight of aerosol former, less than or equal to 25 percent by weight of aerosol former, or less than or equal to 20 percent by weight of aerosol former. That is, the aerosol-forming substrate may have an aerosol former content of less than or equal to 30 percent by weight, less than or equal to 25 percent by weight, or less than or equal to 20 percent by weight.

The aerosol-forming substrate may comprise between 1 percent and 30 percent by weight of aerosol former, between 1 percent and 25 percent by weight of aerosol former, or between 1 percent and 20 percent by weight of aerosol former.

The aerosol-forming substrate may comprise between 5 percent and 30 percent by weight of aerosol former, between 5 percent and 25 percent by weight of aerosol former, or between 5 percent and 20 percent by weight of aerosol former.

The aerosol-forming substrate may comprise between 10 percent and 30 percent by weight of aerosol former, between 10 percent and 25 percent by weight of aerosol former, or between 10 percent and 20 percent by weight of aerosol former.

The aerosol-forming substrate may comprise between 15 percent and 30 percent by weight of aerosol former, between 15 percent and 25 percent by weight of aerosol former, or between 15 percent and 20 percent by weight of aerosol former.

The aerosol-forming substrate may comprise at least 50 percent by weight of aerosol former, at least 60 percent by weight of aerosol former, or at least 70 percent by weight of aerosol former.

The aerosol-forming substrate may comprise less than or equal to 85 percent by weight of aerosol former, less than or equal to 80 percent by weight of aerosol former, or less than or equal to 75 percent by weight of aerosol former.

The aerosol-forming substrate may comprise between 50 percent and 85 percent by weight of aerosol former, between 50 percent and 80 percent by weight of aerosol former, or between 50 percent and 75 percent by weight of aerosol former.

The aerosol-forming substrate may comprise between 60 percent and 85 percent by weight of aerosol former, between 60 percent and 80 percent by weight of aerosol former, or between 60 percent and 75 percent by weight of aerosol former.

The aerosol-forming substrate may comprise between 70 percent and 85 percent by weight of aerosol former, between 70 percent and 80 percent by weight of aerosol former, or between 70 percent and 75 percent by weight of aerosol former.

The aerosol-forming substrate may comprise nicotine. The aerosol-forming material may comprise natural nicotine, or synthetic nicotine, or a combination of natural nicotine and synthetic nicotine.

The aerosol-forming substrate may comprise at least 0.5 percent by weight of nicotine, at least 1 percent by weight of nicotine, at least 1.5 percent by weight of nicotine, or at least 2 percent by weight of nicotine. That is, the aerosol-forming substrate may have a nicotine content of at least 0.5 percent by weight, at least 1 percent by weight, at least 1.5 percent by weight, or at least 2 percent by weight.

The aerosol-forming substrate may comprise one or more cannabinoid compounds such as one or more of: tetrahydrocannabinol (THC), tetrahydrocannabinolic acid (THCA), cannabidiol (CBD), cannabidiolic acid (CBDA), cannabinol (CBN), cannabigerol (CBG), cannabigerol monomethyl ether (CBGM), cannabivarin (CBV), cannabidivarin (CBDV), tetrahydrocannabivarin (THCV), cannabichromene (CBC), cannabicyclol (CBL), cannabichromevarin (CBCV), cannabigerovarin (CBGV), cannabielsoin (CBE), cannabicitran (CBT). It may be preferable that the cannabinoid compound is CBD or THC. It may be particularly preferable that the cannabinoid compound is CBD.

The aerosol-forming substrate may comprise one or more flavourants. The one or more flavourants may comprise one or more of: one or more essential oils such as eugenol, peppermint oil and spearmint oil; one or both of menthol and eugenol; one or both of anethole and linalool; and a herbaceous material. Suitable herbaceous material includes herb leaf or other herbaceous material from herbaceous plants including, but not limited to, mints, such as peppermint and spearmint, lemon balm, basil, cinnamon, lemon basil, chive, coriander, lavender, sage, tea, thyme, and caraway. The one or more flavourants may comprise a tobacco material.

The aerosol-forming substrate may have a moisture content of about 5 to 25%, preferably of about 7 to 15%, at final product state. For example, the aerosol-forming substrate may be a homogenised tobacco material with a moisture of about 5 to 25%, preferably of about 7 to 15%, at final product state.

The aerosol-forming substrate may comprise tobacco leaf; for example about 15 to 45%, preferably of about 20 to 35% of a blend of tobacco leaf, incorporating at least one of the following tobacco types: bright tobacco; dark tobacco; aromatic tobacco. Tobacco material such as tobacco leaf is preferably ground and graded to a particle size of about 100 to 380 mesh, preferably of about 170 to 320 mesh.

“Tobacco type” means one of the different varieties of tobacco, for example based on the distinct curing process that the tobacco undergoes before it is further processed in a tobacco product.

Examples of bright tobaccos are Flue-Cured Brazil, Indian Flue-Cured, Chinese Flue-Cured, US Flue-Cured such as Virginia tobacco, and Flue-Cured from Tanzania.

Examples of aromatic tobaccos are Oriental Turkey, Greek Oriental, semi-oriental tobacco but also Fire Cured, US Burley, such as Perique, and Rustica.

Examples of dark tobacco are Dark Cured Brazil Galpao, Burley Malawi or other African Burley, Sun Cured or Air Cured Indonesian Kasturi.

The aerosol-forming substrate may comprise Cellulose fibres. For example, the aerosol-forming substrate may comprise about 1 to 15% of cellulose fibres, preferably of about 3 to 7% of cellulose fibres. Preferably, cellulose fibres may have a length of about 10 to 250 μm, preferably of about 10 to 120 μm.

The aerosol-forming substrate may comprise organic fibres such as non-tobacco fibres, or tobacco fibres. For example, the aerosol-forming substrate may comprise about 5 to 20%, preferably about 7 to 15% of tobacco fibres. Tobacco fibres are preferably derived from stems and/or or stalks, graded to fibres of a length of about 10 to 350 μm, preferably of about 10 to 180 μm. The aerosol-forming substrate may comprise about 10 to 30%, preferably of about 15 to 25%, of a non-tobacco organic fibre. For example, organic fibres may derive from cellulose, cotton, wood, tea botanical varieties as sub-products, and sub-processed waste, the tea industry. Organic fibres are preferably of a length of about 10 to 400 μm, preferably of about 10 to 200 μm.

The aerosol-forming substrate may comprise a binder. For example, the aerosol-forming substrate may comprise about 1 to 10%, preferably of about 1 to 5%, of a binder such as any of common gums or pectins used in food and beverage (F&B) industries. Preferred binders may be natural pectins, such as fruit, for example citrus, or tobacco pectins; guar gums, land locust bean gums, such as hydroxyethyl and/or hydroxypropyl of those; starches, such as modified or derivatized starches; alginate; methyl, ethyl, ethylhydroxymethyl and carboxymethyl, celluloses; dextran; and xanthan gum. A preferable binder is guar.

The aerosol-forming substrate may comprise an organic botanical glycerite. For example, the aerosol-forming substrate may comprise about 15 to 55%, preferably of about 20 to 35%, of botanicals such as Clove, Echinacea sp., Fennel, Ginger, Hawthorn berry, Elderberry, Monarda, Mullein leaves, Nettle, Plantain, Turmeric, Yarrow, and compounds of those.

The aerosol-forming substrate may comprise organic botanical extracts. For example, the aerosol-forming substrate may comprise about 1 to 15%, preferably of about 2 to 7%, of any of the previously referred botanicals, as well as menthol (dl-Menthol, C₁₀H₂₀O, 2-Isopropyl-5-methylcyclohexanol) such as obtained from Chaerophyllum macrospermum, Mesosphaerum sidifolium, or other related botanic varieties, as well as P-menthan-3-ol, as any secondary alcohol as diastereoisomers of 5-methyl-2-(propan-2-yl)cyclohexan-1-ol.

The aerosol-forming substrate may comprise botanical essential oils, for example about 0.5 to 5%, preferably of about 1 to 3%, of a botanical essential oil, for example a botanical essential oil such as of palm, coconut, and wooden-based essential oils.

The aerosol-forming substrate preferably comprises an aerosol-former, for example about 5 to 35%, preferably of about 10 to 25%, of an aerosol former. Suitable aerosol-formers known in the art include: glycerine; monohydric alcohols like menthol, polyhydric alcohols, such as triethylene glycol; esters of polyhydric alcohols, such as glycerol mono-, di- or triacetate; and aliphatic esters of mono-, di- or polycarboxylic acids, such as dimethyls of those.

Paper and cardboard are primarily composed of cellulose (for example, cellulose fibres). By way of example, paper and cardboard may be made from wood pulp, cotton, flax, straw, hemp and jute. Paper and cardboard may comprise lignin; for example, where paper and cardboard include cellulose fibres and lignin, lignin facilitates binding the cellulose fibres together. Cardboard may be single-ply or multi-ply. The term cardboard encompasses paperboard.

As used herein, the term “aerosol-generating article” may refer to an article able to generate, or release, an aerosol.

As used herein, the term “aerosol-forming substrate” may refer to a substrate capable of releasing an aerosol or volatile compounds that can form an aerosol. Such volatile compounds may be released by heating the aerosol-forming substrate. An aerosol-forming substrate may comprise an aerosol-forming material. An aerosol-forming substrate may be adsorbed, coated, impregnated, or otherwise loaded onto a carrier or support. An aerosol-forming substrate may conveniently be part of an aerosol-generating article or smoking article.

As used herein, the term “aerosol-generating device” may refer to a device for use with an aerosol-generating article to enable the generation, or release, of an aerosol.

As used herein, the term “aerosol generating system” refers to a combination of an aerosol-generating device and one or more aerosol-forming articles for use with the device. An aerosol-generating system may include additional components, such as a charging unit for recharging an on-board electric power supply in an electrically operated or electric aerosol-generating device.

As used herein, the term “aerosol former” may refer to any suitable known compound or mixture of compounds that, in use, facilitates formation of an aerosol. The aerosol may be a dense and stable aerosol. The aerosol may be substantially resistant to thermal degradation at the operating temperature of the aerosol-forming substrate or aerosol-generating article.

As used herein with reference to the invention, the term “nicotine”, is used to describe nicotine, nicotine base or a nicotine salt.

As used herein with reference to the invention, the terms “proximal”, “distal”, “upstream” and “downstream” are used to describe the relative positions of components, or portions of components, of the aerosol-generating article.

As used herein, the term “longitudinal” refers to the direction corresponding to the main longitudinal axis of the aerosol-generating article, which extends between the upstream and downstream ends of the aerosol-generating article. During use, air may be drawn through the aerosol-generating article in the longitudinal direction.

As used herein, the term “sheet” denotes a laminar element having a width and length substantially greater than the thickness thereof. The width of a sheet may be greater than 10 mm, preferably greater than 20 mm or 30 mm. In certain embodiments, sheets of material for use in forming aerosol-forming substrates as described herein may have a thickness of between 10 μm and about 1000 μm, for example between 10 μm and about 300 μm.

As used herein, the term “homogenised tobacco material” encompasses any tobacco material formed by the agglomeration of particles of tobacco material. Sheets or webs of homogenised tobacco material are formed by agglomerating particulate tobacco obtained by grinding or otherwise powdering of one or both of tobacco leaf lamina and tobacco leaf stems. In addition, homogenised tobacco material may comprise a minor quantity of one or more of tobacco dust, tobacco fines, and other particulate tobacco by-products formed during the treating, handling and shipping of tobacco. The sheets of homogenised tobacco material may be produced by casting, extrusion, paper making processes or other any other suitable processes known in the art.

The term “cast leaf” is used herein to refer to a product made by a casting process that is based on casting a slurry comprising plant particles (for example, clove particles or tobacco particles and clove particles in a mixture) and a binder (for example, guar gum) onto a supportive surface, such as a belt conveyor, drying the slurry and removing the dried sheet from the supportive surface. An example of the casting or cast leaf process is described in, for example, U.S. Pat. No. A-5,724,998 for making cast leaf tobacco. In a cast leaf process, particulate plant materials are produced by pulverizing, grinding, or comminuting parts of the plant. The particles produced from one or more plants are mixed with a liquid component, typically water, to form a slurry. Other components in the slurry may include fibres, a binder and an aerosol former. The particulate plant materials may be agglomerated in the presence of the binder. The slurry is cast onto a supportive surface and dried into a sheet of homogenized plant material. Preferably, homogenized plant material used in articles according to the present invention may be produced by casting. Such homogenized plant material may comprise agglomerated particulate plant material.

As used herein, resistance to draw is expressed with the units of pressure “mm H₂O” or “mm WG” or “mm of water gauge” and may be measured in accordance with ISO 6565:2002.

The invention is defined in the claims. However, below there is provided a non-exhaustive list of non-limiting examples. Any one or more of the features of these examples may be combined with any one or more features of another example, embodiment, or aspect described herein.
Example Ex1: An aerosol-generating article for use with an aerosol-generating device, the aerosol-generating article comprising:
a substantially planar upper surface and a substantially planar lower surface;
an aerosol-forming substrate;
the upper surface and the lower surface vertically spaced from each other by a height defined in a z direction;
wherein at least 50% wt of the aerosol-generating article is paper or cardboard.
Example Ex2: An aerosol-generating article according to Ex1, wherein at least 55% wt, or at least 60% wt, or at least 65 % wt, or at least 70% wt, or at least 75% wt, or at least 80% wt, or at least 85% wt, or at least 90% wt of the aerosol-generating article, excluding the aerosol-forming substrate, is paper or cardboard.
Example Ex3: An aerosol-generating article according to Ex2, wherein substantially the entirety of the aerosol-generating article, excluding the aerosol-forming substrate and (if present) adhesive, is paper or cardboard.
Example Ex4: An aerosol-generating article according to any one of Ex1 to Ex3, wherein the aerosol-generating article has a cellulose acetate content of less than 5%, or less than 3%, or less than 1%.
Example Ex5: An aerosol-generating article according to any one of Ex1 to Ex4, the aerosol-generating article comprising a frame disposed between the substantially planar upper surface and the substantially planar lower surface, the frame defining one or more cavities, wherein the frame comprises or consists of paper or cardboard.
Example Ex6: An aerosol-generating article according to any one of Ex1 to Ex5, the aerosol-generating article comprising a laminated structure disposed between the substantially planar upper surface and the substantially planar lower surface, the laminated structure comprising two or more layers overlying each other, wherein the layers comprise or consist of paper or cardboard.
Example Ex7: An aerosol-generating article according to Ex6, wherein the layers of the laminated structure are bonded to each other by an adhesive, optionally the adhesive being guar gum or PVOH.
Example Ex8: An aerosol-generating article according to either one of Ex6 or Ex7, wherein each of the layers extends over a length of the aerosol-generating article.
Example Ex9: An aerosol-generating article according to any one of Ex6 to Ex8, wherein each of the layers of the laminated structure has a thickness in a range of between 0.1 millimetres to 5 millimetres, or between 0.4 millimetres to 4 millimetres, or about 0.5 millimetres, or about 1 millimetres.
Example Ex10: An aerosol-generating article according to Ex9, wherein the laminated structure defines at least part of an air flow path through the aerosol-generating article between a distal end and a proximal end of the aerosol-generating article.
Example Ex11: An aerosol-generating article according to Ex10, wherein the laminated structure defines a frame, the frame defining one or more cavities, the air flow path extending through the cavity.
Example Ex12: An aerosol-generating article according to Ex11, wherein at least part of the aerosol-forming substrate is disposed in the cavity.
Example Ex13: An aerosol-generating article according to any one of Ex5 to Ex12, wherein the paper or cardboard content of the frame or the laminated structure has a basis weight equal to or greater than 300 grammes per square metre, or a basis weight equal to or greater than 350 grammes per square metre, or a basis weight equal to or greater than 390 grammes per square metre, or a basis weight equal to or greater than 420 grammes per square metre, or a basis weight equal to or greater than 620 grammes per square metre, or a basis weight equal to or greater than 720 grammes per square metre, or a basis weight equal to or greater than 800 grammes per square metre.
Example Ex13A: An aerosol-generating article according to any one of Ex5 to Ex13, wherein the paper or cardboard content of the frame or the laminated structure has a basis weight equal to or less than 900 grammes per square metre, or a basis weight equal to or less than 800 grammes per square metre, or a basis weight equal to or less than 720 grammes per square metre, or a basis weight equal to or less than 620 grammes per square metre, or a basis weight equal to or less than 420 grammes per square metre, or a basis weight equal to or less than 390 grammes per square metre, or a basis weight equal to or less than 350 grammes per square metre.
Example Ex13B: An aerosol-generating article according to any one of Ex5 to Ex13A, wherein the paper or cardboard content of the frame or the laminated structure has a basis weight between 300 grammes per square metre to 900 grammes per square metre, or a basis weight between 300 grammes per square metre to 800 grammes per square metre, or a basis weight between 350 grammes per square metre to 800 grammes per square metre, or a basis weight between 400 grammes per square metre to 700 grammes per square metre.
Example Ex14: An aerosol-generating article according to any one of Ex5 to Ex13B, wherein the frame or the laminated structure extends in a z direction over at least 85%, or at least 90%, or at least 95%, or at least 97.5%, or 100% of the height.
Example Ex15: An aerosol-generating article according to any one of Ex5 to Ex14, wherein the frame or the laminated structure has a height defined in a z-direction, the height of the frame or the laminated structure being no more than 5 millimetres.
Example Ex16: An aerosol-generating article according to any one of Ex1 to Ex15, wherein the upper surface and the lower surface are parallel to each other.
Example Ex17: An aerosol-generating article according to any one of Ex1 to Ex16, wherein the aerosol-generating article has a length extending between a distal end and a proximal end of the aerosol-generating article, the aerosol-forming substrate extending over at least part of the length of the aerosol-generating article, optionally the aerosol-forming substrate extending over the entire length of the aerosol-generating article.
Example Ex18: An aerosol-generating article according to Ex17, wherein the aerosol-forming substrate extends over part of the length of the aerosol-generating article and is positioned to be closer to the distal end than to the proximal end.
Example Ex19: An aerosol-generating article according to either one of Ex17 or Ex18, wherein the aerosol-forming substrate extends to the distal end.
Example Ex20: An aerosol-generating article according to any one of Ex17 to Ex19, wherein the proximal end is a mouth end of the aerosol-generating article.
Example Ex20a: An aerosol-generating article according to any one of Ex1 to Ex20, wherein an air-flow path is defined through the aerosol-generating article between a distal end and a proximal end of the aerosol-generating article.
Example Ex21: An aerosol-generating article according to any one of Ex1 to Ex20a, further comprising an intermediate layer arranged between an upper layer and a lower layer, the upper surface defining an external surface of the upper layer and the lower surface defining an external surface of the lower layer, wherein an air flow path is defined through the aerosol-generating article in an x/y plane between a distal end and a proximal end of the aerosol-generating article. Example Ex22: An aerosol-generating article according to Ex21, wherein a resistance to draw (RTD) of the aerosol-generating article, along the air-flow path, is less than 20 millimetre H₂O.
Example Ex23: An aerosol-generating article according to either one of Ex21 or Ex22, wherein one or more of the upper layer, the intermediate layer and the lower layer comprise or consist of paper or cardboard.
Example Ex24: An aerosol-generating article according to any one of Ex21 to Ex23, wherein one or both of the upper layer and the lower layer comprise or consist of aerosol-forming substrate, the intermediate layer comprising or consisting of paper or cardboard.
Example Ex25: An aerosol-generating article according to any one of Ex21 to Ex23, wherein the intermediate layer comprises or consists of aerosol-forming substrate, the upper layer and the lower layer comprising or consisting of paper or cardboard.
Example Ex26: An aerosol-generating article according to any one of Ex21 to Ex25, wherein a plurality of longitudinally extending channels are defined by corrugations between the upper layer and the intermediate layer and between the intermediate layer and the lower layer.
Example Ex27: An aerosol-generating article according to Ex26, wherein the longitudinally extending channels extend along in an x/y plane between the distal end and the proximal end.
Example Ex28: An aerosol-generating article according to any one of Ex21 to Ex27, wherein the intermediate layer is fixed relative to at least one of the upper layer and lower layer by an adhesive, for example in which the adhesive comprises guar gum, optionally in which the adhesive comprises an aerosol-forming material such as homogenised tobacco slurry.
Example Ex29: An aerosol-generating article according to any one of Ex21 to Ex28, wherein the intermediate layer comprises a corrugated element.
Example Ex30: An aerosol-generating article according to Ex29, wherein the corrugated element comprises or consists of aerosol-forming substrate.
Example Ex30a: An aerosol-generating article according to Ex29, wherein the corrugated element comprises or consists of paper or cardboard.
Example Ex31: An aerosol-generating article according to any one of Ex29 to Ex30a, wherein the intermediate layer comprises a plurality of corrugated elements, in which two or more of the plurality of corrugated elements are arranged in vertical relationship to each other between the upper layer and the lower layer.
Example Ex32: An aerosol-generating article according to Ex31, wherein the intermediate layer further comprises a planar element positioned between two of the plurality of corrugated elements.
Example Ex33: An aerosol-generating article according to any one of Ex1 to Ex20a, further comprising a planar frame positioned between an upper layer and a lower layer, the upper surface defining an external surface of the upper layer and the lower surface defining an external surface of the lower layer, the planar frame defining a cavity, wherein an air flow path is defined through the aerosol-generating article in an x/y plane, the air-flow path extending through the cavity.
Example Ex34: An aerosol-generating article according to Ex33, wherein the upper layer and the lower layer are coupled to opposing surfaces of the frame to overlie opposing ends of the cavity.
Example Ex35: An aerosol-generating article according to either one of Ex33 or Ex34, wherein one or more of the upper layer, the lower layer and the frame comprise or consist of paper or cardboard.
Example Ex35A: An aerosol-generating article according to Ex35, wherein at least the frame comprises or consists of paper or cardboard.
Example Ex35B: An aerosol-generating article according to either one of Ex35 or Ex35A, wherein each of the upper layer, the lower layer and the frame comprise or consist of paper or cardboard.
Example Ex35C: An aerosol-generating article according to any one of Ex35 to Ex35B, wherein the paper or cardboard content of the frame has a basis weight equal to or greater than 300 grammes per square metre, or a basis weight equal to or greater than 350 grammes per square metre, or a basis weight equal to or greater than 390 grammes per square metre, or a basis weight equal to or greater than 420 grammes per square metre, or a basis weight equal to or greater than 620 grammes per square metre, or a basis weight equal to or greater than 720 grammes per square metre, or a basis weight equal to or greater than 800 grammes per square metre.
Example Ex35D: An aerosol-generating article according to any one of Ex35 to Ex35C, wherein the paper or cardboard content of the frame or the laminated article has a basis weight equal to or less than 900 grammes per square metre, or a basis weight equal to or less than 800 grammes per square metre, or a basis weight equal to or less than 720 grammes per square metre, or a basis weight equal to or less than 620 grammes per square metre, or a basis weight equal to or less than 420 grammes per square metre, or a basis weight equal to or less than 390 grammes per square metre, or a basis weight equal to or less than 350 grammes per square metre.
Example Ex35E: An aerosol-generating article according to any one of Ex35 to Ex35D, wherein the paper or cardboard content of the frame or the laminated article has a basis weight between 300 grammes per square metre to 900 grammes per square metre, or a basis weight between 300 grammes per square metre to 800 grammes per square metre, or a basis weight between 350 grammes per square metre to 800 grammes per square metre, or a basis weight between 400 grammes per square metre to 700 grammes per square metre.
Example Ex36: An aerosol-generating article according to any one of Ex33 to Ex35D, wherein one or both of the upper layer and the lower layer comprise or consist of aerosol-forming substrate, the frame comprising or consisting of paper or cardboard.
Example Ex37: An aerosol-generating article according to any one of Ex33 to Ex35D, wherein both the upper layer and the lower layer comprise or consist of paper or cardboard, the frame comprising or consisting of aerosol-forming substrate.
Example Ex38: An aerosol-generating article according to any one of Ex33 to Ex35D, wherein each of the upper layer, the lower layer and the frame comprise or consist of paper or cardboard, wherein aerosol-forming substrate is contained within the cavity between the upper and lower layers.
Example Ex39: An aerosol-generating article according to any one of Ex33 to Ex38, wherein a corrugated element is disposed within the cavity between the upper and lower layers.
Example Ex40: An aerosol-generating article according to Ex39, wherein the corrugated element comprises or consists of aerosol-forming substrate.
Example Ex41: An aerosol-generating article according to Ex39, wherein the corrugated element comprises or consists of paper or cardboard.
Example Ex42: An aerosol-generating article according to any one of Ex39 to Ex41, wherein a plurality of longitudinally extending channels are defined by corrugations between the upper layer and the corrugated element and between the corrugated element and the lower layer.
Example Ex43: An aerosol-generating article according to Ex42, wherein the longitudinally extending channels extend along in an x/y plane between opposing ends of the frame.
Example Ex44: An aerosol-generating article according to any one of Ex33 to Ex43, wherein the air-flow path is at least partially defined by the frame.
Example Ex45: An aerosol-generating article according to Ex44, wherein the frame comprises an inlet air-flow channel and an outlet air-flow channel, the inlet air-flow channel configured to permit a flow of air into the cavity and the outlet air-flow channel configured to permit a flow of air to exit the cavity.
Example Ex46: An aerosol-generating article according to Ex45, wherein the inlet air-flow channel and the outlet air-flow channel are defined on opposing ends of the frame.
Example Ex47: An aerosol-generating article according to either one of Ex45 or Ex46, wherein the inlet air-flow channel is defined in a first width edge of the frame and the outlet air-flow channel is defined in a second width edge of the frame.

Examples will now be further described with reference to the figures in which:

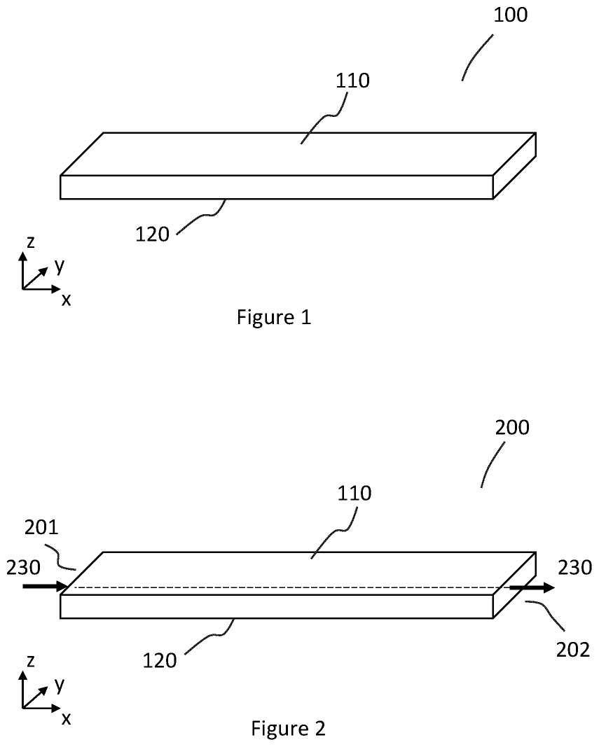

FIG. 1 is a perspective side view of an aerosol-generating article according to a first embodiment of the present disclosure;

FIG. 2 is a perspective side view of an aerosol-generating article according to a second embodiment of the present disclosure;

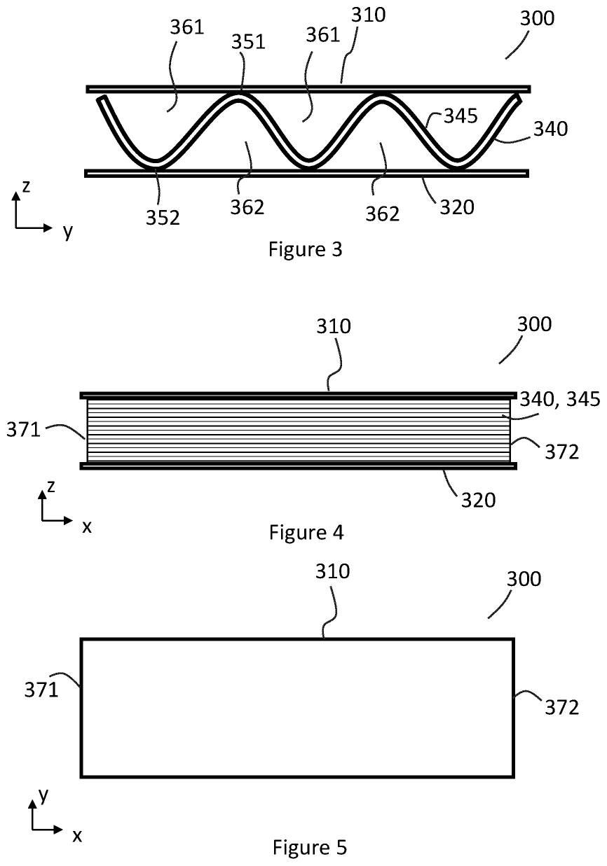

FIG. 3 is a schematic end view of an aerosol-generating article according to a third embodiment of the present disclosure;

FIG. 4 is a schematic side view of the aerosol-generating article of FIG. 3;

FIG. 5 is a schematic plan view of the aerosol-generating article of FIG. 3;

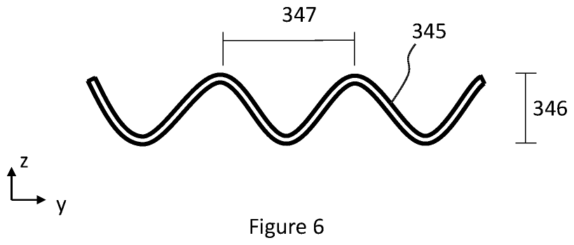

FIG. 6 shows a schematic illustration of a corrugated element as used in the aerosol-generating article of FIG. 3;

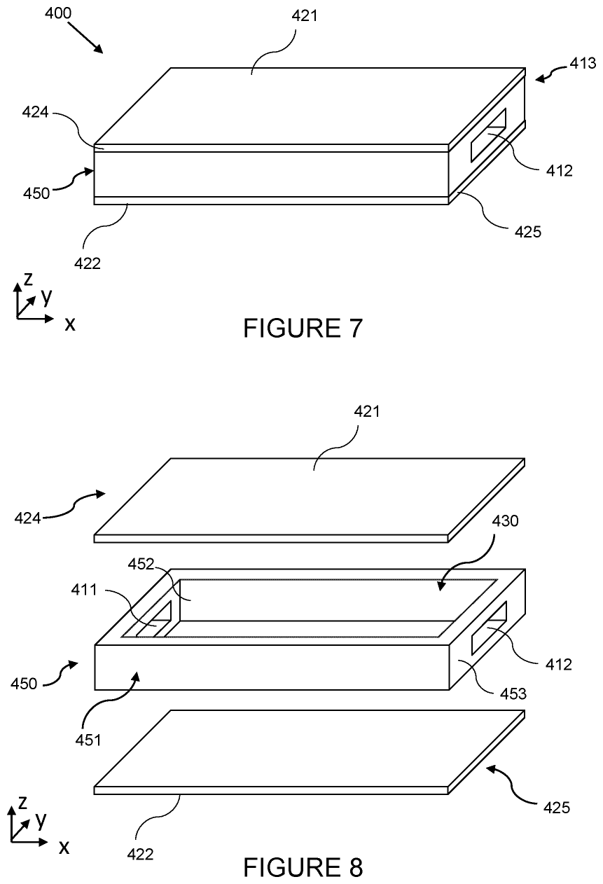

FIG. 7 shows a perspective view of an aerosol-generating article according to a fourth embodiment of the present disclosure;

FIG. 8 shows an exploded perspective view of the aerosol-generating article of FIG. 7;

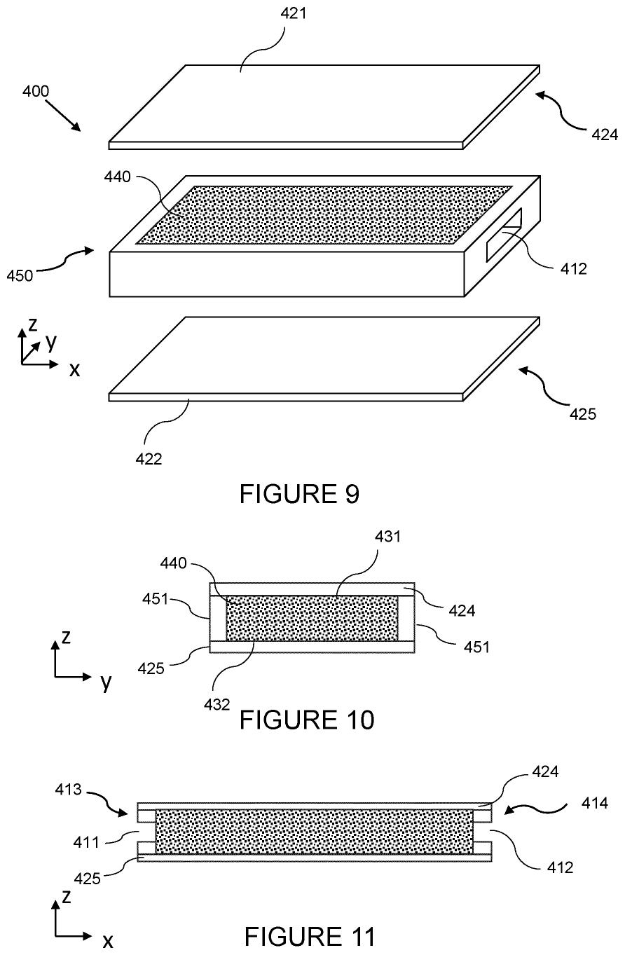

FIG. 9 shows a further exploded perspective view of the aerosol-generating article of FIG. 7;

FIG. 10 shows a schematic transverse cross-sectional view of the aerosol-generating article of FIG. 7;

FIG. 11 shows a schematic longitudinal cross-sectional view of the aerosol-generating article of FIG. 7;

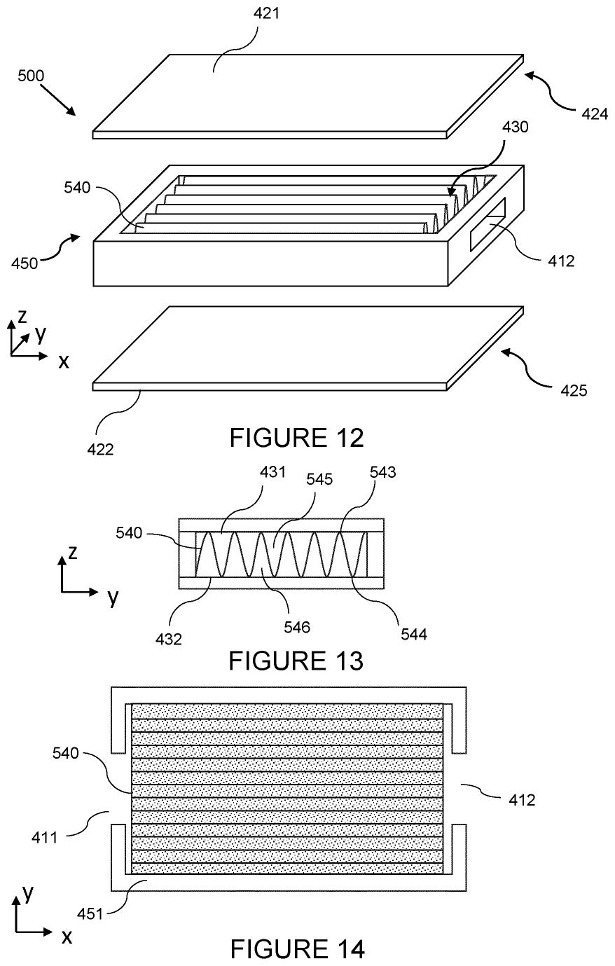

FIG. 12 shows an exploded perspective view of an aerosol-generating article according to a fifth embodiment of the present disclosure;

FIG. 13 shows a schematic transverse cross-sectional view of the aerosol-generating article of FIG. 12;

FIG. 14 shows a schematic lateral cross-sectional view of the aerosol-generating article of FIG. 12.

FIG. 1 illustrates a perspective side view of an aerosol-generating article 100 according to a first embodiment of the present disclosure. The aerosol-generating article 100 has upper and lower surfaces 110, 120 which are flat or planar.

The aerosol-generating article 100 is primarily composed of paper or cardboard, with the aerosol-generating article 100 formed of more than 50% wt of paper or cardboard. The paper and cardboard provide the majority of the flexural rigidity to the aerosol-generating article 100.

The aerosol-generating article 100 also comprises an aerosol-forming substrate (not shown). In another embodiment, the aerosol-forming substrate may be one of a plurality of component parts of the aerosol-generating article 100. The aerosol-forming substrate may be enclosed within an interior of the aerosol-generating article 100. The aerosol-forming substrate may at least partially define an exterior of the aerosol-generating article 100; for example, one or both of the upper and lower surfaces 110, 120 may comprise or consist of aerosol-forming substrate. When excluding the aerosol-forming substrate, the remainder of the aerosol-generating article 100 is substantially composed of paper or cardboard. The aerosol-generating article 100 is free of cellulose acetate.

A suitable aerosol-forming substrate may be homogenised tobacco.

The aerosol-generating article 100 has a length, extending in an x dimension, of 80 millimetres, a width, extending in a y dimension, of 15 millimetres, and a height (which may also be referred to as a thickness), extending in a z dimension, of 3.6 millimetres.

FIG. 2 illustrates a perspective side view of an aerosol-generating article 200 according to a second embodiment of the present disclosure, being a variant of aerosol-generating article 100. Features in common with aerosol-generating article 100 are referred to with like reference signs. An air flow path 230 is defined through the aerosol-generating article 200 between the upper and lower surfaces 110, 120. The air flow path 230 extends between opposed first and second ends 201, 202 of the aerosol-generating article 200. The first end 201 may define a distal end of the aerosol-generating article 200, and the second end 202 may define a proximal end of the aerosol-generating article. The air flow path 230 may be directed towards a mouth of a user to allow a user to inhale aerosol generated in consequence of heating of aerosol-forming substrate of the aerosol-generating article 200.

FIGS. 3, 4, and 5 illustrate respectively an end view, a side view, and a plan view of an aerosol-generating article 300 according to a third embodiment of the present disclosure. The aerosol-generating article 300 comprises a planar upper layer 310, a planar lower layer 320, and an intermediate or separation layer 340 arranged between the upper layer 310 and lower layer 320.

The planar upper layer 310 is formed from a sheet of paper having a thickness of 300 microns. The planar lower layer 320 is formed from a sheet of paper having a thickness of 300 microns. The intermediate layer 340 is a corrugated element formed from a corrugated sheet of aerosol-forming substrate 345. A suitable aerosol-forming substrate may be homogenised tobacco. Thus, the intermediate layer 340 may be formed from a corrugated sheet of homogenised tobacco material 345.

FIG. 6 illustrates the corrugated sheet of aerosol-forming substrate 345. The corrugations have an amplitude 346 of 3 millimetres and a wavelength 347 of 3 millimetres. The sheet of aerosol-forming substrate 345 forming the intermediate layer 340 has a thickness of 150 microns. Points of intersection 351, 352 between the upper layer 310 and the intermediate layer 340 and between the lower layer 320 and the intermediate layer 340 comprise an adhesive that joins the respective layers.

The aerosol-generating article 300 has a length, extending in an x dimension, of 80 millimetres, a width, extending in a y dimension, of 15 millimetres, and a height (or thickness), extending in a z dimension, of 3.6 millimetres. The aerosol-generating article 300 is primarily composed of paper (represented by the planar upper and lower layers 310, 320, which are formed of paper), with the aerosol-generating article 300 formed of more than 50% wt of paper.

Corrugations of the intermediate layer 340 form a first set of longitudinally extending channels 361 that are bounded by the upper layer 310 and the intermediate layer 340, and a second set of longitudinally extending channels 362 bounded by the lower layer 320 and the intermediate layer 340. The first and second sets of longitudinally extending channels 361, 362 extend through the length of the aerosol-forming substrate between a proximal end 371 of the substrate 345 and a distal end 372 of the substrate 345. The longitudinally extending channels 361, 362 define an air-flow path through the substrate 345. The air-flow path, therefore, passes over both sides of the sheet of aerosol-forming substrate 345. The porosity of the aerosol-generating article along the air-flow path is in the region of 90%. This provides a very low resistance to draw (RTD) of less than 5 mm H₂O. In fact, the RTD is close to zero.

The aerosol-forming substrate 345 may be a sheet of any suitable aerosol-forming substrate.

During use of the aerosol-generating article 300, the aerosol-forming substrate 345 is heated up to cause the aerosol-forming substrate 345 to release volatile compounds, which are then entrained in air drawn into the channels 361, 362 via the distal end 372. The volatile compounds then cool and condense to form an aerosol which may be drawn out of the channels 361, 362 of the aerosol-generating article 300 via the proximal end 371.

In other embodiments, the proportion of the mass of the aerosol-generating article 300 defined by the paper-based planar upper and lower layers 310, 320 may be increased by using heavier weight sheets of paper (or cardboard) for the layers 310, 320. In an alternative embodiment, the planar upper and lower layers 310, 320 may instead each be formed from a sheet of aerosol-forming substrate and the intermediate layer 340 formed from a corrugated sheet of cardboard.

FIG. 7 shows an aerosol-generating article 400 according to a fourth embodiment of the present disclosure. The aerosol-generating article 400 comprises a first planar external layer 424 forming a first planar external surface 421, a second planar external layer 425 forming a second planar external surface 422, and a frame 450 positioned between the first planar external layer 424 and the second planar external layer 425. The second planar external surface 422 is positioned parallel to the first planar external surface 421.

FIGS. 8 and 9 show exploded views of the aerosol-generating article 400 of FIG. 7. The frame 450 circumscribes and at least partially defines a cavity 430. FIG. 8 shows the cavity 430 in an empty state. FIG. 9 shows the cavity 430 filled with aerosol-forming substrate 440. FIGS. 10 and 11 show respective transverse and longitudinal cross-sectional views of the aerosol-generating article 400 when the cavity 430 is filled with aerosol-forming substrate 440.

The mass of aerosol-forming substrate 440 in the cavity 430 is 150 milligrammes. However, in other embodiments the mass of aerosol-forming substrate may be lesser or greater in value. For example, the mass of aerosol-forming substrate may be lower in value at 80 milligrammes or higher in value at 500 milligrammes, or be any value between these two values.

The first planar external layer 424 and the second planar external layer 425 are made from cigarette paper having a thickness of 35 micrometres and are in physical contact, with and bonded to, the frame 450. The first planar external layer 424 overlies a first end of the cavity 430 and forms a first cavity end wall 431. The second planar external layer 425 overlies a second end of the cavity 430 and forms a second cavity end wall 432, the second cavity end wall 432 being opposite to the first cavity end wall 431. That is, the frame 450, the first planar external layer 424 and the second planar external layer 425 collectively define the cavity 430.

The first and second planar external layers 424, 425 have a basis weight of 25 grammes per square metre. However, in other embodiments the first and second planar external layers 424, 425 may have a basis weight which is lesser or greater in value. For example, the first and second planar external layers 424, 425 may have a basis weight of between 10 grammes per square metre and 30 grammes per square metre.

The frame 450 has a hollow cuboid shape and is made from cardboard. The frame 450 defines an aperture extending through the height (also referred to as the thickness) of the frame 450 and the aperture at least partially forms the cavity 430 of the aerosol-generating article 400. The frame 450 comprises a peripheral wall 451 that circumscribes the cavity 430. The peripheral wall 451 includes a front wall 413 and a back wall 414. In more detail, the peripheral wall 451 is defined by an inner transverse surface 452 of the frame 450 and an outer transverse surface 453 of the frame 450. The inner transverse surface 452 of the peripheral wall 451 at least partially defines a perimeter of the cavity 430. The outer transverse surface 453 of the peripheral wall 451 at least partially defines a perimeter of the aerosol-generating article 400. The peripheral wall 451 has a radial thickness measured between the inner transverse surface 452 of the frame 450 and the outer transverse surface 453 of the frame 450 of about 5 millimetres.

The cardboard of the frame 450 has a basis weight of 450 grammes per square metre. However, in other embodiments the cardboard of the frame 450 may have a basis weight which is lesser or greater in value. For example, the cardboard of the frame 450 may have a basis weight of between 300 grammes per square metre and 900 grammes per square metre.

Although the frame 450 is shown schematically in these figures as being a homogenous single layer, in other embodiments it will be understood that the frame 450 may be a laminated structure formed from a series of layers of cardboard, each layer extending in the x direction and successively overlaid over each other to define the height of the frame 450. Guar gum or PVOH may be employed as an adhesive to bond the layers to form the frame 450 as a laminated structure. Each of the layers may have a thickness of 0.5 millimetres, although it will be appreciated that the layer thickness may be greater in value (for example, up to 5 millimetres) or lesser in value (for example, down to 0.1 millimetres). An air inlet 411 and an air outlet 412 are defined by, and extend through, the peripheral wall 451 of the frame 450. More specifically, the air inlet 411 extends through the front wall 413 and the air outlet 412 extends through the back wall 414. The air inlet 411 and the air outlet 412 have an equivalent diameter of 5 millimetres. An airflow passage extends between the air inlet 411 and the air outlet 412 through the cavity 430. As shown in FIGS. 9 to 11, an aerosol-forming substrate 440 is positioned within the cavity 430. The aerosol-forming substrate 440 comprises an aerosol-generating material in the form of tobacco cut filler and has an aerosol-former content of 5 percent by weight on a dry weight basis. As shown, the aerosol-forming substrate 440 fills the entire volume of the cavity 430.

The aerosol-generating article 400 has a cuboid shape and has a height (or thickness) extending in a z dimension, as measured between the first planar external surface 421 and the second planar external surface 422, of 8 millimetres, a width extending in a y dimension of 40 millimetres and a length extending in an x dimension of 60 millimetres. The frame 450 has a height (or thickness) extending in a z dimension of 7.93 millimetres, a width extending in a y dimension of 40 millimetres and a length extending in an x dimension of 60 millimetres. The cavity 430 has a height (or thickness) extending in a z dimension of 7.93 millimetres, a width extending in a y dimension of 39.93 millimetres and a length extending in an x dimension of 52 millimetres.

The combination of the frame 450 and the first and second planar external layers 424, 425 form about 64% of the mass of the aerosol-generating article 400. The proportion of the mass of the aerosol-generating article 400 which is formed of paper or cardboard may be further increased by one or more of: i) reducing the mass and/or packing density of aerosol-forming substrate 440 filling the cavity 430, ii) changing the physical dimensions of the first and second planar external layers 424, 425 and/or the frame 450, and iii) changing the basis weight of the material used for the first and second planar external layers 424, 425 and/or the frame 450.

When excluding the aerosol-forming substrate 440 and any adhesive which may be present (for example, where the frame 450 is a laminated structure formed of successive layers bonded to each together by adhesive), substantially the entirety of the aerosol-generating article 400 is formed from paper or cardboard.

FIG. 12 shows an aerosol-generating article 500 according to a fifth embodiment of the present disclosure. Features in common with aerosol-generating article 400 are referred to with like reference signs. Aerosol-generating article 500 differs from aerosol-generating article 400 in that the aerosol-forming substrate is in the form of a sheet of aerosol-generating material 540, in particular a corrugated sheet of homogenised tobacco material. FIGS. 13 and 14 show respective transverse and lateral cross-section views of the aerosol-generating article 500 of FIG. 12. The first and second planar external layers 424, 425 form more than 50% wt of the aerosol-generating article 500.

The corrugated sheet of homogenised tobacco material 540 comprises a plurality of parallel corrugations having a plurality of substantially parallel peaks 543 and troughs 544. The plurality of parallel corrugations are defined by a corrugation profile which, as seen in FIG. 13, is sinusoidal. The plurality of parallel corrugations have a corrugation wavelength of about 4.6 millimetres. The corrugation amplitude is approximately the same as the height (or thickness) of the cavity 430, as shown by the peaks 543 and troughs 544 coinciding with the first cavity end wall 431 and the second cavity end wall 432, respectively.

The plurality of parallel corrugations form a plurality of channels 545 between the sheet of aerosol-generating material 540 and the first cavity end wall 431, and a plurality of channels 546 between the sheet of aerosol-generating material 540 and the second cavity end wall 432. The plurality of channels 545, 546 extend in a longitudinal direction of the aerosol-generating article 500 and form at least a portion of the airflow passage extending between the air inlet 411 and the air outlet 412.

During use of each of the aerosol-generating articles 400, 500, the aerosol-forming substrate 440, 540 is heated up to cause the aerosol-forming substrate 440, 540 to release volatile compounds, which are then entrained in air drawn through the air inlet 411 into the cavity 430. The volatile compounds then cool and condense to form an aerosol which may be drawn out of the aerosol-generating article 400, 500 through the air outlet 412.

For exemplary purposes applicable to any of the embodiments described above, a composition of a suitable aerosol-forming substrate may be as follows. Percentages are given in weight percent with respect to the product in its final state. The aerosol-forming substrate may have a moisture of about 5 to 25%, preferably of about 7 to 15%, at final product state. The aerosol-forming substrate may further comprise the following:
1. Tobacco leaf; for example about 15 to 45%, preferably of about 20 to 35% of a blend of tobacco leaf, incorporating at least one of the following tobacco types: bright tobacco; dark tobacco; aromatic tobacco. Tobacco material is ground and graded to a particle size of about 100 to 380 mesh, preferably of about 170 to 320 mesh.
2. Cellulose fibres; for example about 1 to 15%, preferably of about 3 to 7%, of cellulose fibres, of a length of about 10 to 250 μm, preferably of about 10 to 120 μm.
3. Tobacco fibres; for example about 5 to 20%, preferably of about 7 to 15% of tobacco fibres, as filler, of any tobacco type or a blend of tobacco types. Tobacco fibres are preferably derived from stems and/or or stalks, graded to fibres of a length of about 10 to 350 μm, preferably of about 10 to 180 μm.
4. Binder; for example about 1 to 10%, preferably of about 1 to 5%, of a binder such as any of common gums or pectins used in food and beverage (F&B) industries. Preferred binders may be natural pectins, such as fruit, for example citrus, or tobacco pectins; guar gums, land locust bean gums, such as hydroxyethyl and/or hydroxypropyl of those; starches, such as modified or derivatized starches; alginate; methyl, ethyl, ethylhydroxymethyl and carboxymethyl, celluloses; dextran; and xanthan gum. The preferable binder is guar.
5. Aerosol-former; for example about 5 to 35%, preferably of about 10 to 25%, of an aerosol former. Suitable aerosol-formers known in the art include: glycerine; monohydric alcohols like menthol, polyhydric alcohols, such as triethylene glycol; esters of polyhydric alcohols, such as glycerol mono-, di- or triacetate; and aliphatic esters of mono-, di- or polycarboxylic acids, such as dimethyls of those.

“Tobacco type” means one of the different varieties of tobacco, for example based on the distinct curing process that the tobacco undergoes before it is further processed in a tobacco product.

For exemplary purposes, a composition of a further aerosol-forming substrate, which may also be suitable for use as the aerosol-forming substrate in any of the embodiments described above is described below. Percentages are given in weight percent with respect to the product in its final state. The aerosol-forming substrate may comprise:
1. An aerosol-former such as Glycerin; for example about 10 to 40%, preferably of about 20 to 30%.
2. Organic fibres; for example about 10 to 30%, preferably of about 15 to 25%, of any botanical variety suitable and with purity to comply with applicable FDA F&B grade requirements, as commonly available in the market. For example, organic fibres may derive from cellulose, cotton, wood, tea botanical varieties as sub-products, and sub-processed waste, of F&B tea industry. Organic fibres are preferably of a length of about 10 to 400 μm, preferably of about 10 to 200 μm.
3. Organic botanical glycerite; for example about 15 to 55%, preferably of about 20 to 35%, of botanicals such as Clove, Echinacea sp., Fennel, Ginger, Hawthorn berry, Elderberry, Monarda, Mullein leaves, Nettle, Plantain, Turmeric, Yarrow, and compounds of those.
4. Organic botanical extracts; for example about 1 to 15%, preferably of about 2 to 7 %, of any of the previously referred botanicals, as well as menthol (dl-Menthol, C₁₀H₂₀O, 2-Isopropyl-5-methylcyclohexanol) such as obtained from Chaerophyllum macrospermum, Mesosphaerum sidifolium, or other related botanic varieties, as well as P-menthan-3-ol, as any secondary alcohol as diastereoisomers of 5-methyl-2-(propan-2-yl)cyclohexan-1-ol.

Alternatively, such aerosol-forming substrate may also contain botanical essential oils of about 0.5 to 5%, preferably of about 1 to 3%, such as of palm, coconut, and wooden-based essential oils.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A” ±10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein. The terms “in which” and “wherein” are used synonymously through this specification.

1-15. (canceled)

16. An aerosol-generating article for an aerosol-generating device, the aerosol-generating article comprising:
a substantially planar upper surface and a substantially planar lower surface, the substantially planar upper surface and the substantially planar lower surface being vertically spaced from each other by a height defined in a z direction;
an aerosol-forming substrate; and
a laminated structure disposed between the substantially planar upper surface and the substantially planar lower surface, the laminated structure comprising two or more layers overlying each other, wherein the two or more layers comprise paper or cardboard,
wherein the laminated structure defines at least part of an air flow path through the aerosol-generating article between a distal end and a proximal end of the aerosol-generating article,
wherein the laminated structure further defines a frame, the frame defining one or more cavities, the air flow path extending through the one or more cavities,
wherein at least 50% wt of the aerosol-generating article is paper or cardboard.

17. The aerosol-generating article according to claim 16, wherein at least 55% wt of the aerosol-generating article, excluding the aerosol-forming substrate, is paper or cardboard.

18. The aerosol-generating article according to claim 17, wherein substantially an entirety of the aerosol-generating article, excluding the aerosol-forming substrate, is paper or cardboard.

19. The aerosol-generating article according to claim 16, wherein the aerosol-generating article has a cellulose acetate content of less than 5%.

20. The aerosol-generating article according to claim 16, wherein each of the two or more layers extends over a length of the aerosol-generating article.

21. The aerosol-generating article according to claim 16, wherein each of the two or more layers of the laminated structure has a thickness in a range of between 0.1 millimetre to 5 millimetres.

22. The aerosol-generating article according to claim 16, wherein at least part of the aerosol-forming substrate is disposed in the one or more cavities.

23. The aerosol-generating article according to claim 16, wherein the paper or the cardboard content of the frame or the laminated structure has a basis weight equal to or greater than 300 grammes per square metre.

24. The aerosol-generating article according to claim 16, wherein the frame or the laminated structure extends in the z direction over at least 85% of the height.

25. The aerosol-generating article according to claim 16, wherein the frame or the laminated structure has a height defined in the z-direction, the height of the laminated structure being no more than 5 millimetres.

26. The aerosol-generating article according to claim 16, wherein the upper surface and the lower surface are parallel to each other.

27. The aerosol-generating article according to claim 16,
further comprising an intermediate layer arranged between an upper layer and a lower layer, the substantially planar upper surface defining an external surface of the upper layer and the substantially planar lower surface defining an external surface of the lower layer,
wherein the air flow path is defined through the aerosol-generating article in an x/y plane between the distal end and the proximal end of the aerosol-generating article.

28. The aerosol-generating article according to claim 27, wherein one or more of the upper layer, the intermediate layer, and the lower layer comprise paper or cardboard.

29. The aerosol-generating article according to claim 16,
wherein the frame is a planar frame positioned between an upper layer and a lower layer, the substantially planar upper surface defining an external surface of the upper layer and the substantially planar lower surface defining an external surface of the lower layer, and
wherein the air flow path is defined through the aerosol-generating article in an x/y plane.

30. The aerosol-generating article according to claim 29, wherein one or both of the upper layer and the lower layer comprise paper or cardboard.
